(19) United States
(12) Patent Application Publication
(10) Pub. No.: US 2026/0189065 A1
(43) Pub. Date: Jul. 2, 2026

(54) Branch Circuit Identification

(71) Applicant: Koolbridge Energy, Inc., Wrightsville Beach, NC (US)

(72) Inventor: Jacobus Cornelis Haartsen, Rolde (NL)

(21) Appl. No.: 19/432,261

(22) Filed: Dec. 24, 2025

Related U.S. Application Data
(60) Provisional application No. 63/739,795, filed on Dec. 30, 2024.

(51) Int. Cl. H02J 13/14; H02J 3/466; H02J 13/13; H02J 13/34; H02J 13/38; H02J 101/24; H02J 105/12; H02J 105/42

(52) U.S. Cl. CPC H02J 13/14; H02J 3/466; H02J 13/1335; H02J 13/34; H02J 13/38; H02J 2101/24; H02J 2105/12; H02J 2105/42

(57) ABSTRACT

A communications system is described providing the ability to intelligently deliver electrical power from a first power source or from a second power source to a branch circuit in a facility, such as a home. Communications between a Smart Load Center (SLC) controller and the appliances is provided via wireless signals sent over the air. Sequentially, each branch circuit is powered off while the SLC wirelessly sends a poll message to the appliances. The response messages to the poll message allow the SLC to identify to which branch circuit each appliance is connected. The signals over the air support the communications between the appliances and the SLC controller and may be part of a larger Internet-of-Things ecosystem dedicated to facilities automation services.

### RELATED APPLICATIONS

This application claims the benefit of U.S. Provisional Application No. 63/739795, filed 30 Dec. 2024, the entire disclosure of which being hereby incorporated by reference herein.

### FIELD OF INVENTION

The present invention relates generally to the smart control of appliances by dynamically switching power from either of two power sources, such as grid power and solar panels on a branch circuit basis, and in particular to methods of automatically identifying which appliances are connected to which branch circuits.

### BACKGROUND

In the face of global climate change, generally attributed to the burning of fossil fuels, there is a large interest in renewable power sources, such as solar and wind energy. Global demand has driven the cost of photovoltaic (PV) panels consistently lower. The median installed price of a residential solar panel system was about $100 per watt in the 1970s, dropping to $11 per watt by 2006, and was approximately $3 pre watt in 2024. Lower costs, together with incentives such as the U.S. Residential Clean Energy Credit (previously called the Solar Investment Tax Credit), have contributed to a sharp rise in the installation of both residential and commercial solar power facilities. The U.S. has achieved five million cumulative solar installations by 2023, generating over 36 GW of electricity.

In electrical installations served by an electric utility, power enters the installation at a Service Entrance into a Main Service Panel. In U.S. residential installations, power entering the main service panel comprises two 120-Volt anti-phase 60 Hz feeds designated L1 and L2 plus a common neutral, N. In commercial installations, a 3-phase service is often supplied, comprising L1, L2, L3 and N. In other places in the world, a single-phase residential system may comprise only one 240-Volt 50 Hz feed L, plus N.

The most common method of exploiting solar energy has been the so-called “grid-tied” system, in which DC power from solar cells is converted to AC power and fed backwards through the electrical meter to offset consumption from the grid. Many states in the USA have passed regulations mandating that electrical utilities shall permit this so-called net-metering system, in which the cost of power consumed from the grid at one time of day is offset by a credit received for power fed back to the grid at a different time. However, as the amount of installed solar power increases, the electric utilities are starting to experience difficulties in absorbing the total amount of back-fed power during the peak sun hours and as a result, the end is in sight of the economic benefit for consumers in being able to feed power back to the grid. Additionally, if the electric utility power grid went down, such as due to a weather event, homeowners were unable to directly utilize the solar power they generated, as grid-tied inverters are current sources which match the grid voltage. To drive loads such as lights and appliances, a voltage source inverter is required, which outputs power at a defined voltage, and the appliances consume current as required.

U.S. Pat. No. 8,937,822, assigned to the Assignee of the present disclosure, describes an alternative to net metering for solar power (or other alternative power sources different from the grid power), which instead facilitates self-consumption of own, solar-derived power. In this '822 patent, a Smart Load Center (SLC) is introduced that switches between energy supply sources and electrical appliances within the house or business demanding electrical energy. The SLC system features automatic, circuit-by-circuit transfer switches to select, for each branch circuit, whether it receives solar power or grid power. This decision is based on, among other things, the total amount of solar power present and the load offered by the active appliances in the house or business, at any moment in time. Each branch circuit that is routed through the house provides electrical power to one or more appliances. Typically, several outlets are connected in parallel in the branch circuit, and appliances and other electrical equipment may be plugged into the outlets. Alternatively, higher power appliances may be directly connected branch circuit wiring, without the use of electrical outlets. In order to use solar power to directly power loads, energy storage (i.e., a storage battery) may be used to average out the difference between solar power instantaneously received and the varying consumption of the home or business. Thus, solar energy received when the homeowner is not at home to use it can be stored in the battery and released for use when the homeowner is home. Because the inverter described in the '822 patent is a voltage source type, power is also available from the solar panels or batteries when the grid is in outage.

The energy provisioning and load demand by the appliances can change over time, and dynamic scheduling is preferred. Based on the energy demand in the house and on the energy available from the grid and the alternative power source such as solar, appliances can be connected to grid or solar power. To allow the system to make intelligent decisions for energy supply and demand, two functions must be fulfilled:
Identification of which appliance is connected to which branch circuit, and
Communication from the appliance to the Smart Load Center.

Another trend which has recently received much attention is Home Automation. Home automation is part of a bigger trend called Internet-of-Things (IoT), which is a form of machine-to-machine (M2M) communication where any device can be connected to the Internet, either to provide (sensory) data or to be remotely controlled. For Home Automation, this means that appliances such as the refrigerator, the washing machine, the electric stove, and HVAC, are connected to the Internet and can be queried and controlled remotely via applications (apps) on a smartphone or computer. For ease of use, the communications within the IoT ecosystem in general, and for Home Automation in particular, is wireless, based on standard and widely used protocols such as WiFi and Bluetooth. Release 13 of the 3^{rd} Generation Partnership Project (3GPP) defines three technologies to support M2M communications over cellular networks: Extended Coverage GSM Internet of Things (EC-GSM-IoT), LTE for Machine-Type Communications (LTE-M), and Narrowband Internet of Things (NB-IoT).

U.S. Pat. No. 10,536,039, assigned to the Assignee of the present disclosure, describes a hybrid communication system where a combination of powerline communications (PLC) and wireless communications is used to provide the SLC with an appliance identification and communication means. The disclosure of this patent is hereby incorporated herein by reference in its entirety. The method described in '039 makes use of a dedicated PLC subsystem on each branch circuit to identify which appliance is connected to which branch circuit. While the '039 method represents a significant advance in the state of the art, under some circumstances it may experience performance degradation, such as due to crosstalk between the PLC subsystems on different branch circuits.

The Background section of this document is provided to place aspects of the present disclosure in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later.

According to one or more aspects described herein, novel and nonobvious aspects of a Smart Load Center facilitate the dynamic, selective, programmable provision of power from two or more different sources to individual appliances. The Smart Load Center includes an SLC controller, which controls multiple switch functions, e.g., relays, located in a Smart Power Distribution Unit controlling energy provisioning on a circuit-by-circuit basis. By switching each branch circuit independently between, e.g., grid power and solar power, each appliance or group of appliances may be dynamically driven by either power source. A special “OFF” state in the relays is used to help identify to which branch circuit the appliance is connected. Communication between the Smart Load Center and the appliances is provided wirelessly. The wireless signals support the communications between the appliances and Smart Load Center and may be part of a larger Internet-of-Things ecosystem.

One aspect relates to a method, performed by a SLC controller, of dynamically, selectively, and individually delivering power from one of two or more sources to a smart appliance in a facility. The branch circuit to which the smart appliance is connected is selectively connected to one of the two or more power sources, so as to power the smart appliance from the selected power source.

Another aspect relates to a Smart Load Center. The SLC includes a first input operative to receive electrical power from a first power source and a second input operative to receive electrical power from a second power source. The SLC also includes a plurality of branch circuit outputs and a plurality of switches. Each switch is operative to connect a branch circuit alternatively to the first or second power source. The switch can also be placed in an “OFF” state, in which the associated branch circuit is disconnected from any power source. The SLC includes an SLC controller, which includes a wireless transceiver. While one-by-one each switch is put into an “OFF” state, the SLC controller polls all appliances using the wireless transceiver. Based on the responses from the polling action, the SLC controller may determine which appliances are connected to which branch circuit output.

Still another aspect relates to a smart appliance. The smart appliance includes an electrical load; a processor; and a first wireless transceiver.

### BRIEF DESCRIPTION OF THE DRAWINGS

The present invention will now be described more fully hereinafter with reference to the accompanying drawings, in which aspects of the disclosure are shown. However, this disclosure should not be construed as limited to the aspect set forth herein. Rather, these aspect are provided so that this explanation will be thorough and complete, and will fully convey the scope of the disclosure to those skilled in the art. Like numbers refer to like elements throughout.

FIG. 1 is a functional block diagram of the smart power distribution unit of a Smart Load Center supporting circuit-by-circuit power switching using aspects of the disclosure.

FIGS. 2A-2C show three examples of relay implementations having an “OFF” state.

FIG. 3 is a functional block diagram of the overall architecture of a smart energy provisioning system including the SLC, the branch circuits, and the electrical sockets in a residential home or small business.

FIG. 4 is a functional block diagram of the overall architecture of a smart energy provisioning system including the SLC, the branch circuits, and the connected appliances.

FIG. 5 is a first network diagram of a home automation architecture with the SLC for smart energy provisioning

FIG. 6 is a network diagram of a smart energy provisioning system for control of the power delivered to a smart appliance including the home automation system and the SLC containing a branch circuit with an “OFF” state according to a first aspect.

FIG. 7 is a first timing diagram of the identification procedure to help identify to which branch circuit an appliance is connected using a first wireless protocol and the “OFF” state in the SLC.

FIG. 8 is a second timing diagram of the identification procedure to help identify to which branch circuit an appliance is connected using a first wireless protocol and the SLC containing a branch circuit “OFF” state.

FIG. 9 is a third timing diagram of the identification procedure to help identify to which branch circuit an appliance is connected using a second wireless protocol and the “OFF” state in the SLC.

FIG. 10 is a fourth timing diagram of the identification procedure to help identify to which branch circuit an appliance is connected using a second wireless protocol and the “OFF” state in the SLC.

FIG. 11 is a fifth timing diagram of the identification procedure to help identify to which branch circuit an appliance is connected using a first wireless protocol and the “OFF” state in the SLC.

FIG. 12 is a functional block diagram of representative electronics in a control unit in the smart appliance of FIG. 5.

FIG. 13 is a network diagram of a smart energy provisioning system for control of the power delivered to a smart appliance including the home automation system and the SLC containing a branch circuit “OFF” state according to a second aspect.

FIG. 14 is a functional block diagram of representative electronics in a control unit in the smart appliance of FIG. 13.

FIG. 15 is a flow diagram of a method of dynamically and sequentially placing each branch circuit in an “OFF” state and subsequently wirelessly polling the appliances in order to establish which appliances are connected to which branch circuit.

FIG. 16 is a flow diagram of a method of dynamically and sequentially placing each branch circuit in a “POWER” state and subsequently wirelessly polling the appliances in order to establish which appliances are connected to which branch circuit.

### DETAILED DESCRIPTION

For simplicity and illustrative purposes, the present invention is described by referring mainly to an exemplary aspect thereof. In the following description, numerous specific details are set forth in order to provide a thorough understanding of the present invention. However, it will be readily apparent to one of ordinary skill in the art that the present disclosure may be practiced without limitation to these specific details. In this description, well known methods and structures have not been described in detail so as not to unnecessarily obscure the present disclosure.

Embodiments of the present disclosure relate to identification of appliances and to which branch circuits they are attached, in the context of a dual-source electrical power distribution system. One power source is typically the electrical utility grid. The other power source may comprise any alternative power source, such as solar, wind, generator, hydraulic, geothermal, or the like. For convenience of explanation and without loss of generality, the alternative power source is often referred to herein as solar power. Those of skill in the art will recognize that this is simply a non-limiting example, for the purpose of explanation. The SLC, and the innovative appliance circuit identification methods disclosed herein, are not limited to solar power as the alternative energy source.

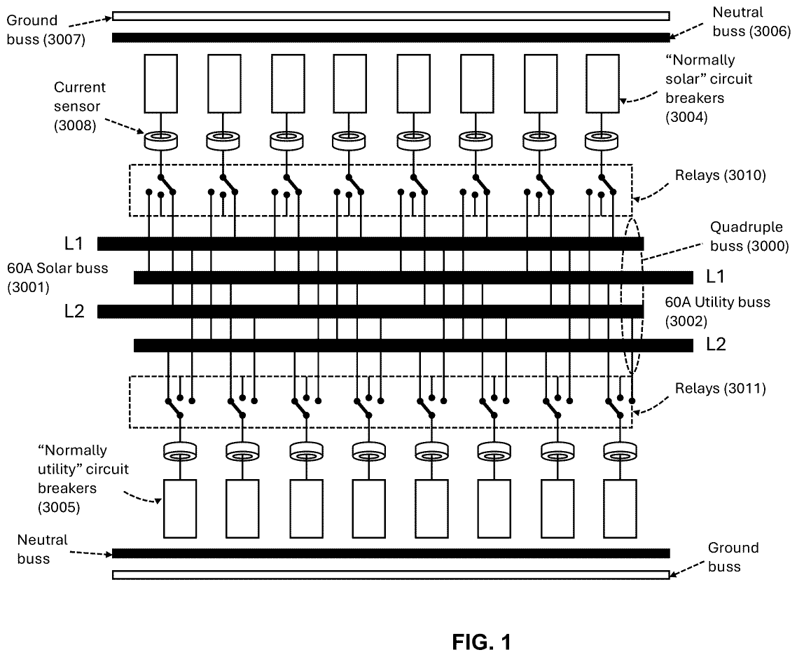

FIG. 1 illustrates the power distribution portion of a Smart Load Center (SLC). It may be seen that, in contrast to the two power busses (L1, L2) that normally extend down the center of a conventional breaker panel, and to which the circuit breakers are connected, the SLC includes four power bus bars - two for solar power or other alternative energy source, and two for utility grid power or other primary energy source. Quadruple bus bar 3000 is preferably sized to handle at least 60 amps on each solar input lug L1 and L2 (3001) and at least 60 amps on each utility power input lug L1 and L2 (3002). The panel of FIG. 1 is typically installed as a sub-panel and fed from the main service panel through a 60 A or 100 A, two-pole feeder breaker. The solar input may be derived from a solar DC-to-AC load inverter (not shown), which is already electronically current limited. Relays 3010/3011 are used to select power to one pole of each breaker, either from one of the solar power bus bars or from a utility power bus bar. On each side, the breakers alternate between using L1 and L2, so that a pair of adjacent slots may be used for a double pole (240 V) circuit, such as may be needed for a well pump or tumble dryer. Each relay is controlled by an SLC controller, which may for example comprise an appropriately programmed microprocessor (not shown in FIG. 1). Interposed between the relays 3010/3011 and circuit breakers 3004/3005 are current sensors 3008, which monitor the actual, real-time current consumption of each branch circuit. Each circuit breaker 3004/3005 leads to a branch circuit (not shown) that is routed through the house, thus providing electrical power to one or more appliances. Typically, several outlets are connected in parallel in the branch circuit, and appliances and other electrical equipment may be plugged into the outlets.

The SLC presented in FIG. 1 differs slightly from the SLC disclosed in the '822 patent. The difference is in the relays 3010/3011 that switch between alternative power and grid power. The relays 3010/3011 in FIG. 1 comprise an “OFF” state. In the “OFF” state, the corresponding branch circuit is completely disconnected from any power source. In this way, the SLC can power down each and every branch circuit separately and independently. In FIG. 1, the middle terminal of the three-terminal-input of relays 3010/3011 provides the “OFF” state.

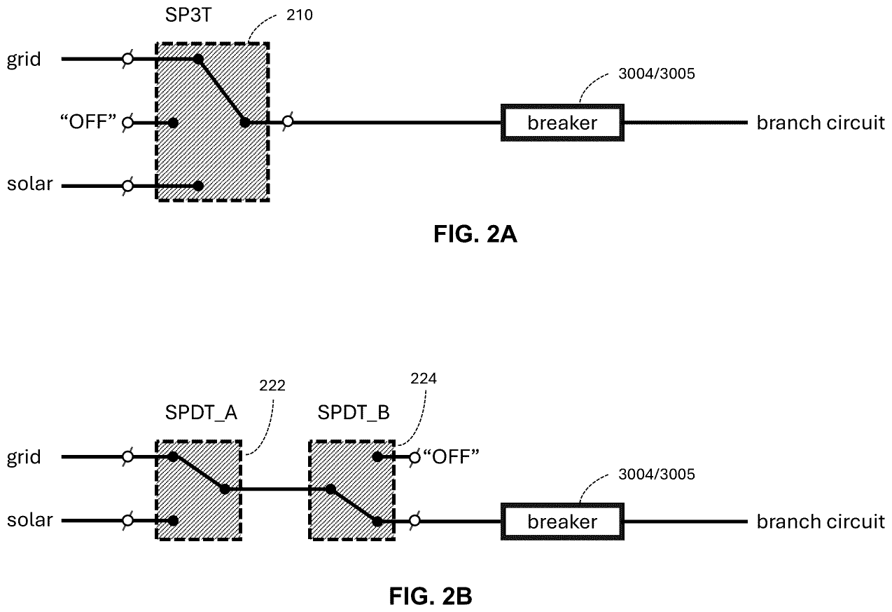

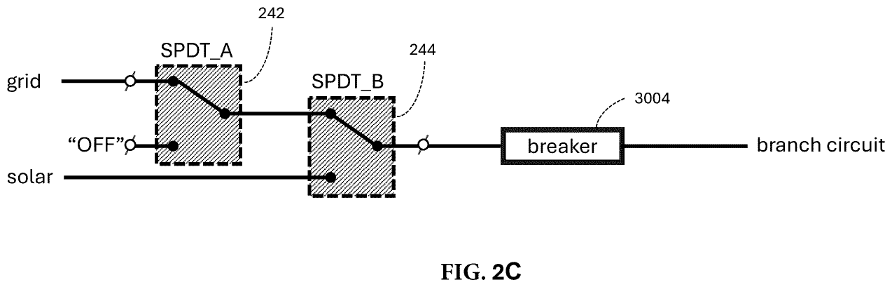

FIGS. 2A-C show several ways the relays 3010/3011 can be implemented. In these examples, the relay switches are shown with three input terminals and one output terminal. The first input terminal is used for the grid power source, the second input terminal is used for the solar power source, and the third input terminal is used for the “OFF” state. The output terminal is connected to the breaker 3004/3005 and the branch circuit.

FIG. 2A shows a configuration where the relay 210 directly switches between three input terminals, also known as a Single-Pole-Triple-Throw (SP3T) relay.

FIG. 2B shows a relay implemented as a cascade of two relays, each with two input terminals and one output terminal. This switch is constructed using two Single-Pole-Double-Throw (SPDT) relays. SPDT_A 222 switches between grid and solar power, SPDT_B 224 switches between the active or “POWER” state and the “OFF” state. In the implementation of FIG. 2B, grid and solar power sources are connected to the input terminals of a single relay SPDT_A.

FIG. 2C shows an aspect where more electrical isolation is achieved between the power sources. Here, the grid power source is connected to SPDT_A 242 whereas the solar power source is connected to SPDT_B 244. Many more implementations of relays can be designed by those of skill in the art. For example, instead of SPDT relays, Single-Pole-Single-Throw (SPST) relays can be used for those relays that switch to an “OFF” state.

The SLC shown in FIG. 1 can also be extended to more than two power sources. For each power source, an additional bus pair L1, L2 is added. Consequently, the relays must switch between more than two buses. For example, an SLC that can switch between the grid and two alternative power sources would require SP4T relays for selecting between grid source, alternative source 1, alternative source 2, and the “OFF” state. Those of skill in the art can make use of multiple SPDT relays in series to achieve the SP4T functionality, given the teachings above regarding SP3T.

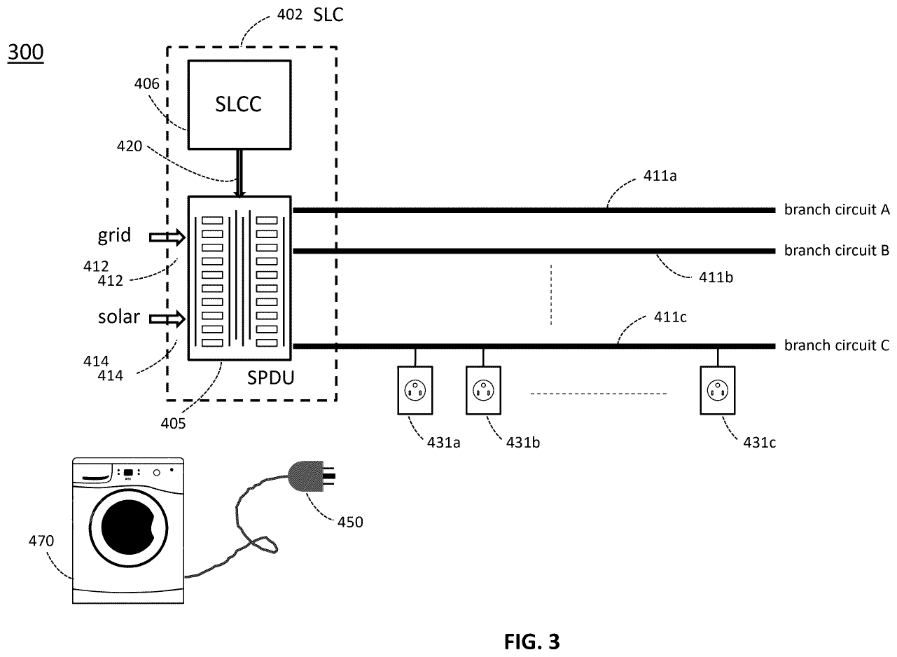

FIG. 3 shows a generalized, high-level overview 300 of dual-power system. A Smart Load Center (SLC) 402 comprises an SLC controller (SLCC) 406 controlling a Smart Power Distribution Unit (SPDU) 405. The SPDU 405 receives both grid power and alternative power (e.g., solar or wind power), and contains circuit breakers and leakage detection circuits such as Ground Fault Circuit Interrupter (GFCI) for electrical protection. The SLCC 406 communicates with the SPDU 405 using communication line 420, which can be a wired link based on UART, USB, or I2C, among others, or a wireless link, for example WiFi or Bluetooth. The SLCC 406 may include one or more wireless transceivers, a processor, memory, and a system control program. Several branch circuits 411 leave the SPDU 405, distributing electrical power over the electrical wiring within the premises.

As depicted in FIG. 1, SP3T relays 3010/3011 are present in the SPDU 405 to connect an individual branch circuit 411 to the grid power, to the alternative energy source, or to turn power off to a branch circuit. Many of the branch circuits 411 include one or more outlets 431. Outlets 431 connected to the same branch circuit 411 either all provide grid power or all provide alternative power.

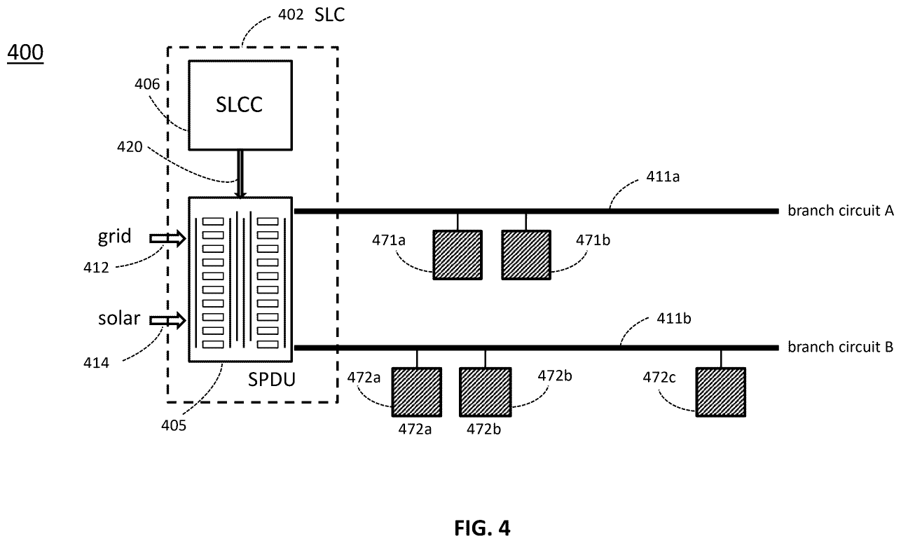

FIG. 4, for example, shows appliances 471a and 471b powered by branch circuit A 411a. When branch circuit 411a is connected to the grid power, appliances 471a and 471b are powered by grid power; when branch circuit 411a is connected to the solar power, appliances 471a and 471b are powered by solar power. Branch circuit B 411b may be connected to a different power source from branch circuit A 411a, in which case appliances 472a, 472b, and 472c retrieve their power from a different power source than appliances 471a, and 471b.

In order for the SLC 402 to connect the appliances 471 and appliances 472 with the proper energy source, the SLCC 406 should know to which branch circuit 411 the appliances 471 and 472 are connected. For this, the “OFF” state provided by the relays 3010/3011 is exploited. When a branch circuit is switched to the “OFF” state, all power provided to the appliances connected to this branch circuit is interrupted. The impact of this interruption can be detected by the wireless network existing between the SLC and the appliances, as discussed below.

Currently, there is a growing interest in a new technology called Internet-of-Things (IoT). In an IoT network, each machine is able to connect (wirelessly) to the internet. The concept of machine can be interpreted very broadly, ranging from a streetlamp to a washing machine. In addition, Home Automation receives quite some attention from big industry players in the consumer industry, such as Google, Apple, Amazon, Whirlpool, GE, etc. When all machines and devices in the home are in some way connected wirelessly, they can be controlled from a central point in the house, or even remotely via a smartphone. Although called Internet-of-Things, this does not necessarily mean that the appliances are connected to the public internet. The (wireless) network may be a closed system, only controlled locally by a central controller. The network may also be an (home) intranet or another private network, isolated from the public internet.

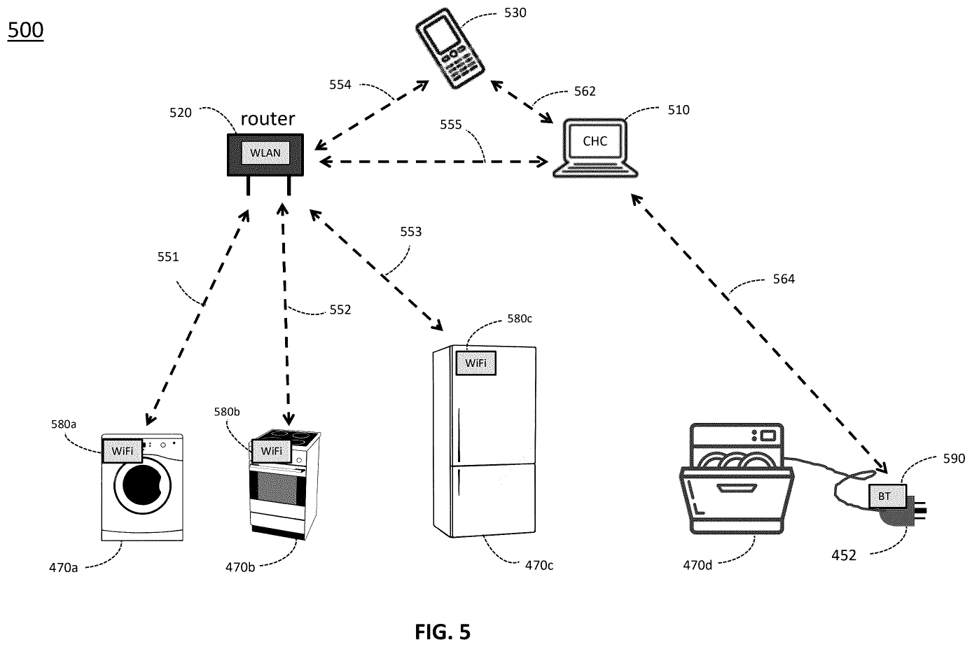

In FIG. 5, a typical Home Automation architecture 500 is shown as envisioned by many players in the industry. Machines and devices are wirelessly linked via connections 551-555 that make use of a wireless network technology using an RF technology such as WiFi (IEEE 802.11 WLAN), ZigBee (IEEE 802.15.4), Bluetooth, or some proprietary standard such as Z-Wave. A wireless local area network (WLAN) router 520 provides coverage in the home (possibly including the garden, garage, barn, or the like, possibly by using a repeater) and may connect to various home appliances such as a washing machine 470a, a stove 470b, and a refrigerator 470c. These appliances are remotely controlled via a Central Home Controller 510 (CHC), for example a personal computer. In addition, the appliances 470 may be controlled remotely via an app on a smartphone 530 that controls the appliances via the router 520 and wireless links 551-553, or via the CHC 510 using wireless link 562, which may use a different wireless standard than wireless links 551-553. Different short-range radio technologies can be supported by the smartphone 530 to support the link 562, e.g., Bluetooth or WiFi-Direct.

Currently, so-called smart appliances 470 from different vendors are entering the market. These appliances are equipped with a wireless transceiver 580 supporting WiFi and may include Bluetooth as well, and thus form part of the IoT ecosystem. Not all appliances may be equipped with a wireless transceiver 580. In the example of FIG. 5, dishwasher 470d does not have a transceiver built in. Instead, the plug 450 that is put into an outlet may have a transceiver 590 which can communicate with the CHC 510 directly via wireless link 564 (preferably a Bluetooth connection). The plug may also have a WiFi transceiver (not shown in FIG. 5) that may connect to WLAN router 520 and reach the CHC 510 via router 520 and link 555.

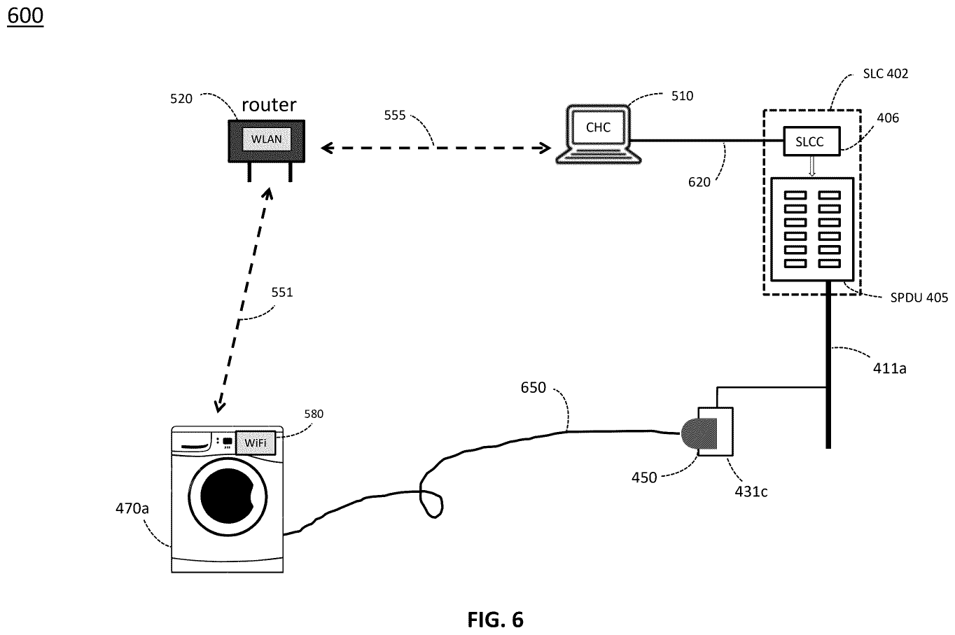

In FIG. 6, the Home Automation architecture 500 of FIG. 5 is combined with the SLC configuration 300 shown in FIG. 3. CHC 510 is connected to SLCC 406 via a wired or wireless link 620. Alternatively, the CHC functionality may be embedded in SLCC 406. To identify which appliance in the home automation system is connected to which branch circuit, the branch circuits are sequentially put into the “OFF” state. All appliances connected to the same branch circuit that is put into the “OFF” state will lose power. As a result, the appliances will be disconnected from home network served by the WLAN router 520. This is detected by CHC 510. In FIG. 6, for example, washing machine 470a is connected to the home network via wireless link 551 to the WLAN router 520. The washing machine is connected via a power cable 650, plug 450, and outlet 431c to branch circuit 411a. When CHC 510 controls SLCC 406 to put branch circuit 411a into the “OFF” state, transceiver 580 in the washing machine 470a will be powered down, and connection 551 will no longer exist. When CHC 510 wirelessly tries to reach washing machine 470a, it will fail. From this, CHC 510 can deduce that washing machine 470a is powered by branch circuit 411a, since this was the only branch circuit powered down by SLCC 406 at the time of the query.

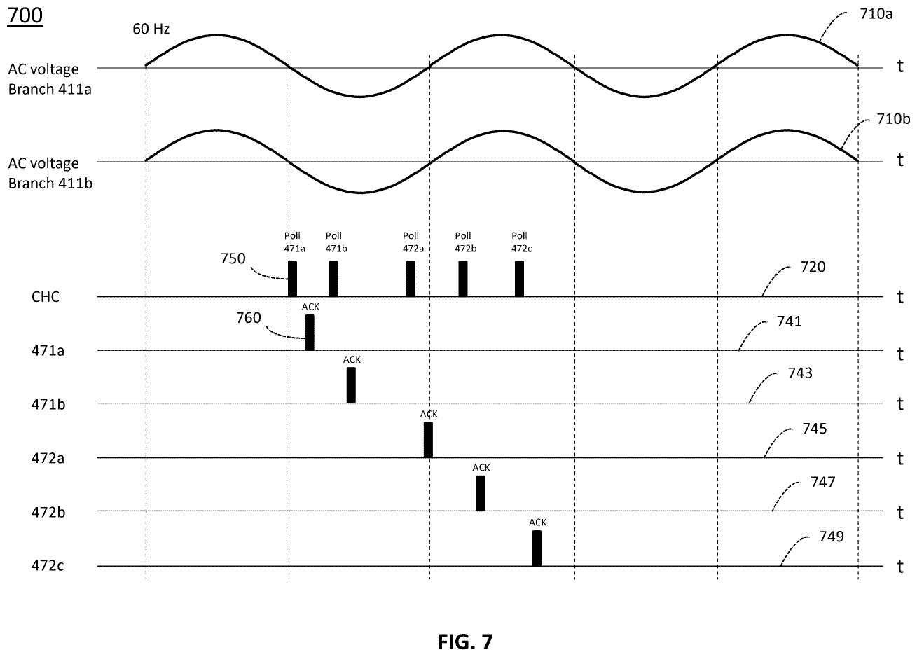

FIG. 7 shows an example where, during the “OFF” time, the wireless system can explicitly poll the registered appliances to check whether they are alive. In this example, two appliances 471a-b are connected to branch circuit 411a, and three appliances 472a-c are connected to branch circuit 411b, as was visualized in FIG. 4. CHC 510 sequentially sends a poll packet to each of the five appliances, see the timing diagram 720 of the poll transmissions 750 sent via router 520. Since all appliances are powered all of the time (see the signal waveforms 710a and 710b of the 60 Hz voltage on branch circuits 411a and 411b, respectively), each appliance will respond with an ACK packet 760 as acknowledgement that it is alive, as is visualized in timing graphs 741, 743, 745, 474, and 749. This method of polling is also called round robin polling; in each round, CHC 510 polls each appliance individually.

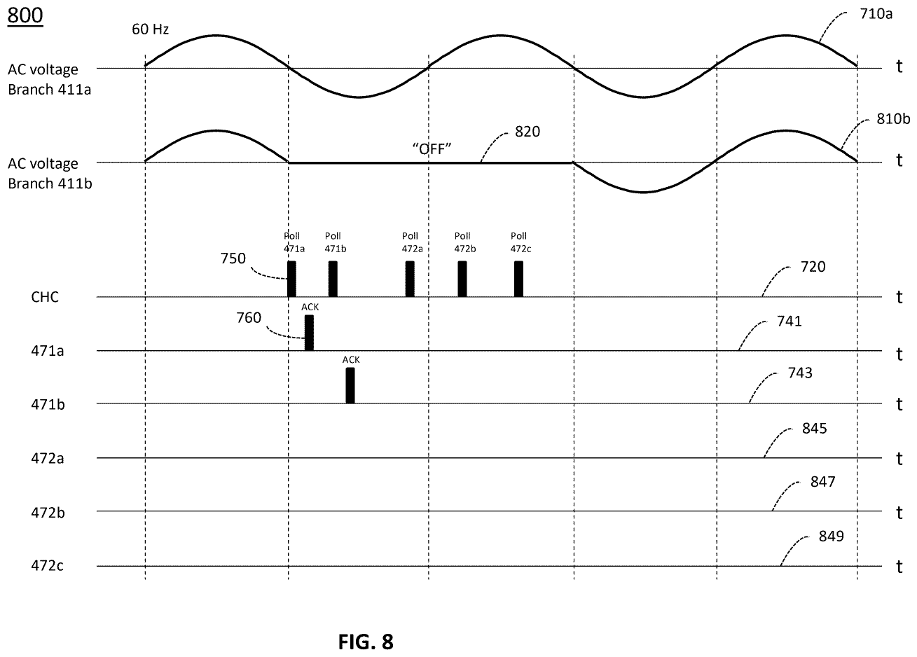

In FIG. 8, branch circuit 411b is put into the “OFF” state for a certain duration of time 820. During this time, appliances connected to branch circuit 411b will not respond to poll packets: i.e., appliances 472a, 472b, and 472c will not respond to poll packets. As a result, the CHC 510 can conclude that appliances 472a, 472b, and 472c are connected branch circuit 411b.

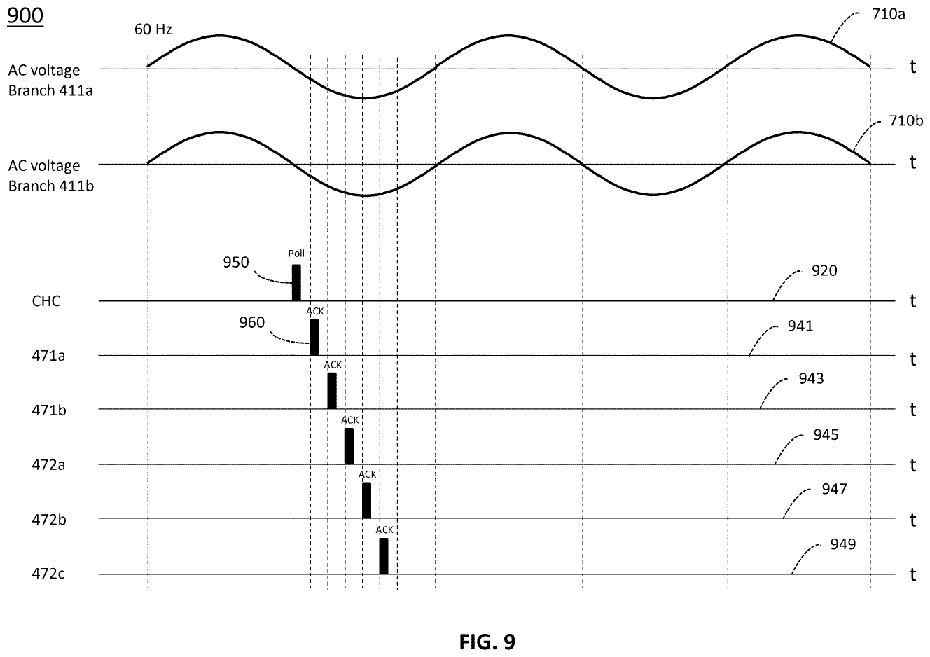

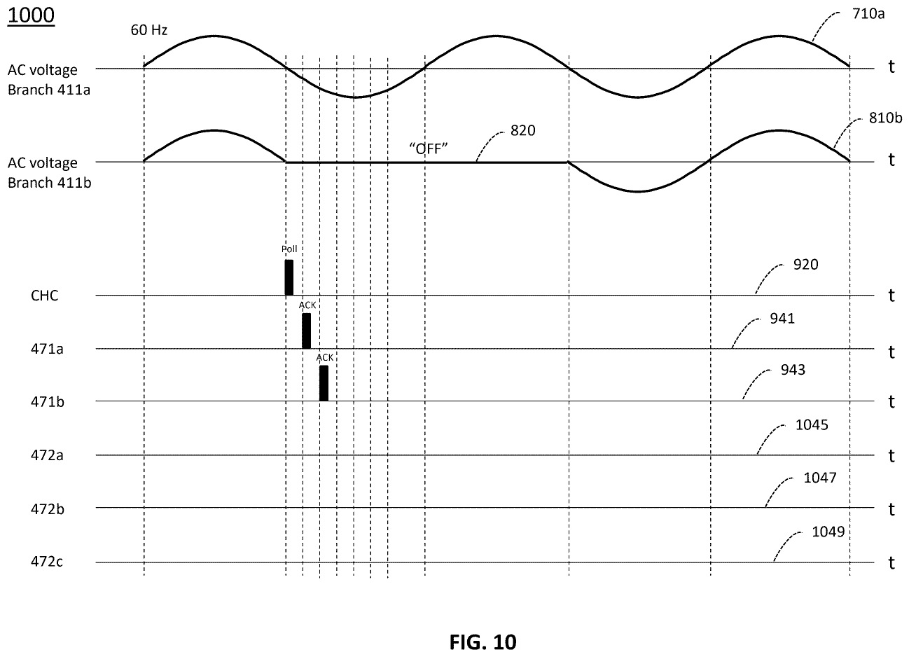

FIGS. 9 and 10 show one of several polling and response mechanisms that may be used. For example, a polling scheme is shown where a single poll packet is broadcasted to all appliances and appliances use reserved time slots for ACK responses. At registration, each appliance is allocated a reserved acknowledgment time slot. In the polling mechanism 900 shown in FIG. 9, router 520 broadcasts a poll packet 950 which is received by all appliances. In turn, each appliance alive will respond with an ACK packet 960 in its allocated response time slot.

FIG. 10 shows that appliances powered down because the branch circuit is in the “OFF” state, will not reply in their allocated slots. This is the case with appliances 472a-c connected to branch circuit 411b which is in the “OFF” state during the polling operation. Instead of reserved time slots, reserved frequencies can be used (Frequency Division Multiple Access FDMA) or orthogonal spreading codes (Code Division Multiple Access CDMA). Alternative polling schemes may be used that may use contention-based or contention-free response mechanisms. Furthermore, existing polling schemes, such as those as defined in the IEEE 802.11 (WiFi) standard or Bluetooth standard, may be used.

Instead of putting sequentially each branch circuit in an “OFF” state while keeping all others powered on, the opposite can be applied as well: all branch circuits are in “OFF” state (powered off) and sequentially, each branch circuit is switched “ON” to apply the polling process, and thereafter turned off again. This is typically the case when the SLC system is installed in the residence. After an electrician has installed the SLC 402, it will run through an initialization procedure. During this procedure, sequentially each branch circuit is turned on and off. When turned on, appliances with wireless transceivers 580 will register themselves at the CHC 510 via wireless router 520. The SLCC 406 will inform CHC 510 which branch circuit is powered on. As a result, the CHC 510 knows that all appliances that have registered recently are connected to this branch circuit. After all branch circuits have been turned on and off again, CHC 510 has a complete picture of which appliance is connected to which branch circuit.

When at a later stage a new appliance is added (i.e. plugged into an arbitrary active outlet) it will turn on and when it contains a wireless transceiver 580, it will register itself at CHC 510 via wireless router 520. At that moment, the appliance can inform the CHC 510 what kind of appliance it is (dryer, washing machine, refrigerator, and so on), its capabilities, and its specifications (e.g., peak current). When it is a washing machine and is about to start a washing program, it may inform the CHC 510 what kind of program (e.g., ECO with lower peak load), and when the washing cycle starts and stops. The CHC 510 can then anticipate the load and apply load balancing within the home, switching between grid and alternative energy to optimize the homeowner's use of power.

To identify to which branch circuit this new appliance is connected, the procedure as shown in FIGS. 7-10 may be carried out. That is, sequentially, branch circuits are turned off for a short duration until the new appliance does not response to a poll because it is powered down. When the duration of the “OFF” state is short enough (e.g., a few tens of milliseconds), other appliances in operation and connected to the same branch circuit may not be hindered in their performance, as they can miss a few 60 Hz cycles before they enter a reset mode. The polling time duration can be very fast. If needed, the polling time duration can be split into many short durations, where during each polling event only a few appliances are polled.

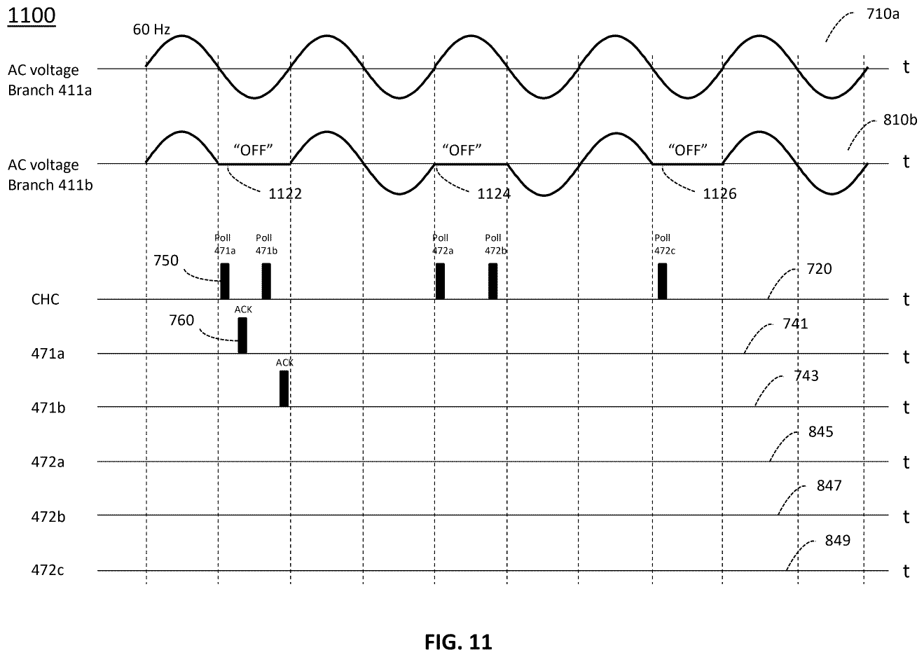

FIG. 11 shows split polling, using the polling method of FIGS. 7 and 8 as an example. Suppose only an interruption of half a power cycle is permitted and suppose that during this time the wireless system can only poll two appliances (i.e., within a time duration of about 8 ms). In FIG. 11, during the first “OFF” period 1122, appliances 471a and 471b are polled. They both send ACK responses because they are connected to branch circuit 411a which has no “OFF” periods. Next, during “OFF” period 1124, appliances 472a and 472b are polled. They do not respond because branch circuit 411b is in “OFF” state during the polling. Finally, during “OFF” period 1126, appliance 472c is polled. This appliance is also connected to branch circuit 411b which is in “OFF” state during the polling; appliance 472c therefore will not respond. After three poll periods, the SLCC can derive that appliances 472a, 472b, and 472c are connected to branch circuit 411b. By spreading out the “OFF” events in time on a single branch circuit and time synchronizing the polling events with the “OFF” events, polling can be accomplished without hindering the other appliances, which already have been identified to be connected to branch circuit 411b and which may be in operation.

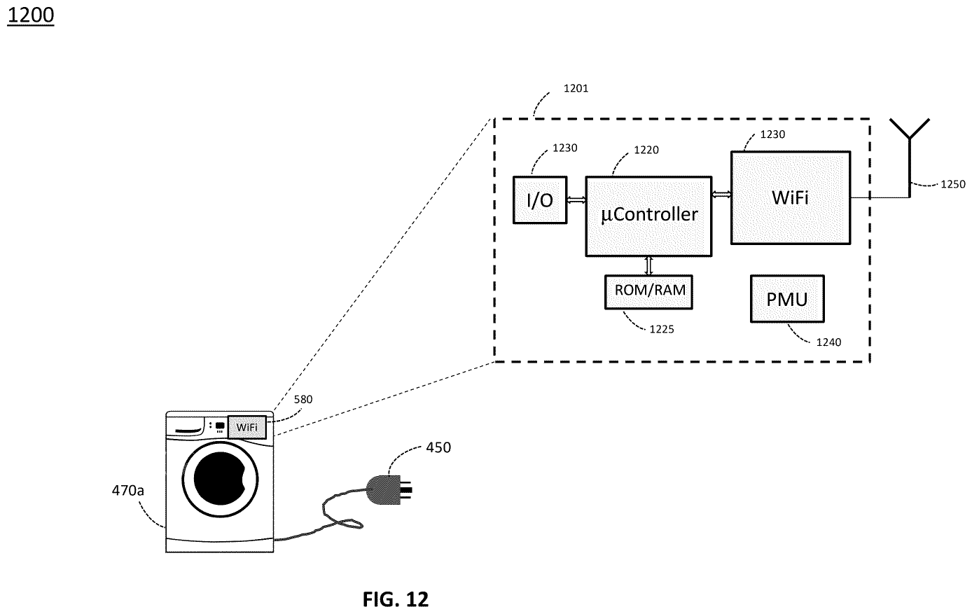

FIG. 12 shows a configuration of a transceiver unit 580 of appliance 470a according to one aspect. The transceiver unit 580 comprises several functional blocks, which may be implemented by electronic components mounted on a Printed Circuit Board (PCB) 1201. Microcontroller 1220 may control the functioning of the appliance 470a directed by a program residing in memory 1225, which may be external or may be integrated on the microcontroller chip 1220. I/O ports 1230 support the communications between motors, sensors, and actuators inside the appliance 470 and the microcontroller 1220. Also located on the PCB 1001 is a WiFi radio 1230 to connect wirelessly to wireless router 520. An antenna 1250 tuned to the proper RF carrier is present to transmit and receive the wireless signals. A Power Management Unit 1040 (PMU) converts the 120 VAC power to suitable DC voltage levels supporting the electronics on the PCB 1201 (e.g., 1.8 V).

The home automation configuration 600 as shown in FIG. 6 requires a WLAN transceiver 580 embedded in each appliance 470. Many smart appliances today have WiFi connectivity. Some even have Bluetooth connectivity. Yet, when the appliance does not WiFi transceiver onboard, the appliance can still be accepted in the home automation network by using a smart plug 452 as was discussed and shown in FIG. 5.

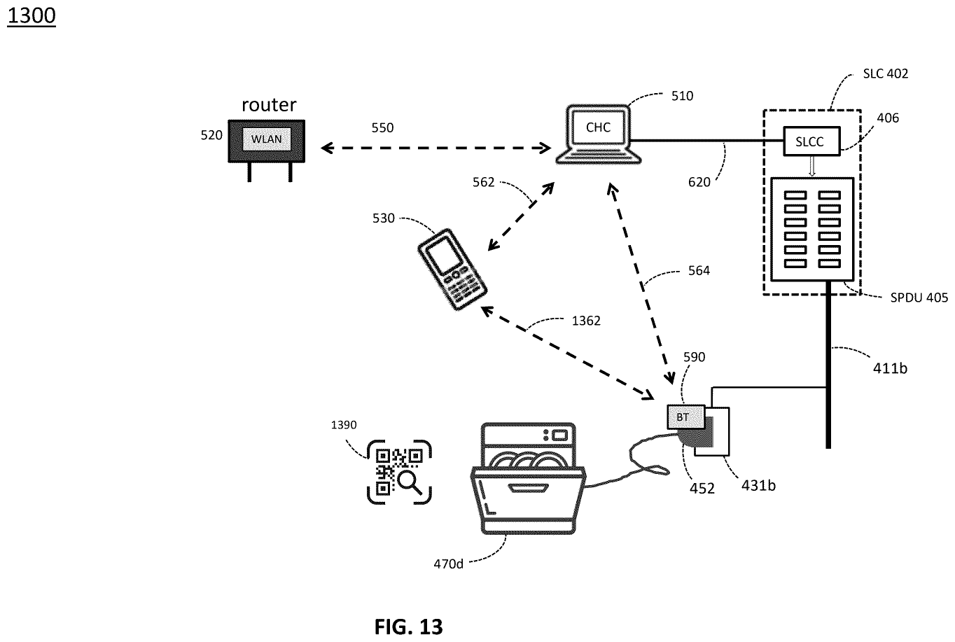

FIG. 13 shows one example, a dishwasher 470d, which has no wireless transceiver built in. Instead, the dishwasher is equipped with a smart plug 452 which includes a wireless transceiver 590. If this wireless transceiver 590 is compatible with WLAN, it will connect to router 520. The identification procedure to find the branch circuit to which the appliance is connected can be carried out as discussed above for an appliance with an embedded transceiver 580. Alternatively, the plug may be equipped with a Bluetooth radio as this will be a very low-cost solution. In high volumes, Bluetooth Low-Energy chip prices are at or below 1 USD. Preferably, the long-range PHY mode of the Bluetooth Low Energy (LE) standard is used, which gives a longer range in challenging residential environments. Alternatively, the Bluetooth mesh networking mode may be used, which provides extensive coverage by hopping from Bluetooth device to Bluetooth device. The smart plug 452 is connected to CHC 510 via link 564 (either directly or via one or more intermediate Bluetooth devices in case of mesh networking) as shown in FIG. 13. The home automation configuration 1300 assumes CHC 510 is equipped with a Bluetooth (long-range) transceiver. The CHC 510 will now carry out the polling process via the Bluetooth connection 564 while the SLCC 406 sequentially switches the branch circuits to an “OFF” state. Bluetooth transceiver 590 will not respond to a poll when the branch circuit 411b to which it is connected is powered down.

Plug 452 may be replacing a dumb plug 450, and later attached to appliance 470d. In that case, the plug has no information about the appliances (such as its capabilities, specifications, and so on). Instead, the smartphone 530 may be used to assist in setting up the appliance 470d. Several scenarios are within the scope of the present disclosure. When the plug 452 is plugged into the outlet 431b and powered on, the smartphone 530 may connect to plug 452 via Bluetooth link 1362. Via a smart app (part of the Home Automation system 500), the user may be prompted to give information about the newly added appliance. A query can be shown on the smartphone screen where the user answers questions such as what kind of appliance it is, what make, a type number, etc. Possibly, the appliance has an optical code, such as a QR code 1390, on its side which can be scanned by the smartphone and which provides the smartphone will all the information of the appliance, or encodes a URL to a website that has such information. This information, combined with the Bluetooth ID (Bluetooth Device Address or BD-ADDR) of plug 452 is sent by the smartphone 530 to CHC 510 via wireless (Bluetooth) link 562. Alternatively, this information may be sent by the smartphone 530 to the smart plug 452 via link 1362 where the information is stored in BT transceiver 590 in nonvolatile memory, and is subsequently sent via link 564 to CHC 510. In the next stage, plug 452 will connect to CHC 510 via wireless (Bluetooth) link 564.

Instead of embedding the Bluetooth (BT) transceiver 590 in plug 452, transceiver 590 may also be embedded in outlet 431. When an appliance is plugged in (using a dumb plug 450), smartphone 530 may be used to configure the setup as discussed above with reference to the smart plug. The BT transceiver 590 may be put into an initialization mode (e.g., by detecting the insertion of the plug 450, or a small push button pushed by a user interaction) after which the smartphone 530 connects to the BT transceiver 590 in the outlet. Alternatively, there may be a QR code or the like on the outlet which conveys the BT transceiver's BD_ADDR or helps in connecting the smartphone 530 and BT transceiver 590.

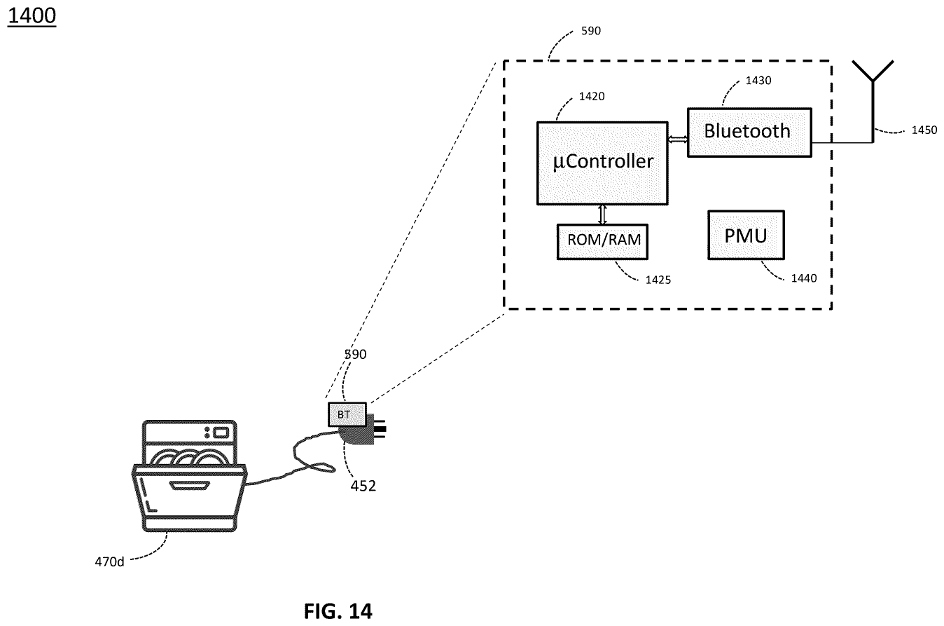

FIG. 14 depicts the electronics, according to one aspect, of the smart plug 452. These components may be integrated onto a printed circuit board (PCB) 1401. A Bluetooth (Low Energy) transceiver 1430 is connected to antenna 1450 to support a wireless link to the CHC 510 or smartphone 530. Transceiver 1430 is connected to microcontroller 1420 which has internal RAM and ROM, and may have external memory (e.g., non-volatile flash memory). A power management unit 1440 is present to provide the proper power supply to the electronics. In one aspect, the microcontroller 1420, memory 1425, and Bluetooth transceiver 1430 may be integrated into a single chip.

In some aspects, transceivers 580 and 590 may be equipped with back-up batteries (for example rechargeable lithium-ion batteries or supercaps) to overcome (short) periods of power outage. These back-up batteries would nullify the mechanism of identifying the connected branch circuit based on the “OFF” state in the SLC. In these aspects, a dedicated detection circuit may be included in transceivers 580 and 590 that identifies when the power supply via the outlet disappears and the transceiver switches to power from the back-up battery. This electronics detection system may be added to the PMU 1240 and 1440 in transceivers 580 and 590, respectively. The back-up battery is not shown in FIGS. 12 and 14, but if present it is typically connected to the PMU. The PMU circuit will control the re-charging of the back-up battery and/or manage switching to the back-up battery when the outlet power vanishes. Existing smart appliances equipped with a WLAN transceiver (e.g., based on WiFi) may have a back-up battery but not a detection mechanism to detect the power outage. In that case, the appliance 470 may be equipped with a smart plug 452 or a smart outlet (smart plug and/or smart outlet should include the power outage detection circuitry if either contains a back-up battery). At setup of the smart plug, its BD-ADDR is associated with the smart appliance using the smartphone App. The branch circuit identification takes place via the smart plug, and because the smart plug is associated with a known smart appliance consequently the CHC 510 knowns to which branch circuit the smart appliance is connected.

In the extreme case of no smart appliances or smart plugs or smart outlets which can detect the power outage on a branch circuit, a very hands-on procedure can be carried out by a person switching on each branch circuit (e.g., by flipping the circuit breakers) one by one and identifying which appliances are powered on, and subsequently entering this information into CHC 510. Alternatively, a computer program running on the CHC 510 may, via SLCC 406, switch on each branch circuit one by one and prompt the user for input related to the appliances that are found to be powered on. Conversely, instead of powering branch circuits on one by one and finding which appliances are working, the branch circuits can be powered off one by one and the user can find which appliances are not working.

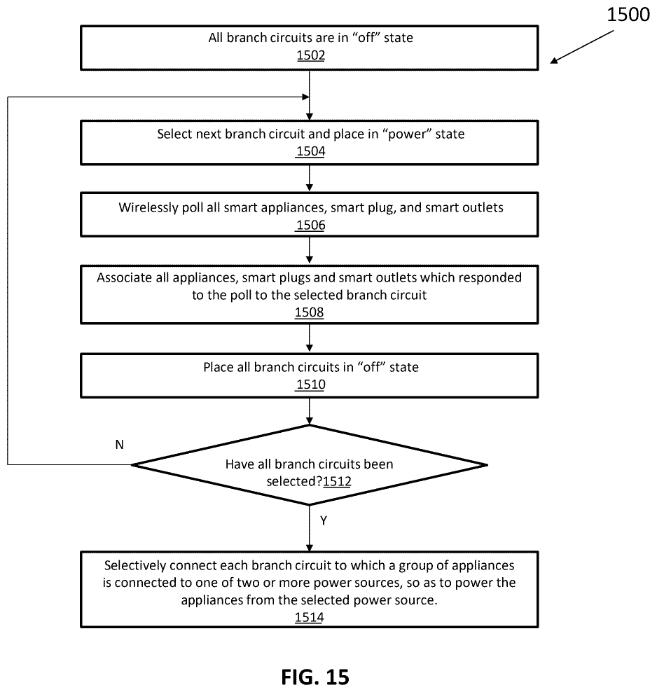

FIG. 15 depicts a method 1500, performed by CHC 510 (whether embedded in the SLC 402, in SLCC 406, or operating independently), of dynamically identifying which appliances are connected to which branch circuit. Each branch circuit is placed in an “OFF” state where no power is provided to the branch circuits (block 1502). Next, one branch circuit is placed in a “POWER” state, meaning it is connected to the grid power or an alternative power source (block 1504). While one branch circuit is in “POWER” state, a wireless polling scheme is used to poll all smart appliances, smart plugs, and smart outlets (block 1506). All smart appliances, smart plugs, and smart outlets that respond to the wireless poll are associated with the selected branch circuit that has been placed in the “POWER” state (block 1508). All branch circuits are placed in “OFF” state again (block 1510). The procedure should be carried out for each branch circuit (block 1512). If not all branch circuits have been selected, the procedure is repeated (back to block 1504). If all branch circuits have been selected, the branch circuits are each “powered” with grid power or an alternative power source depending on the needs of the connected appliances (block 1514).

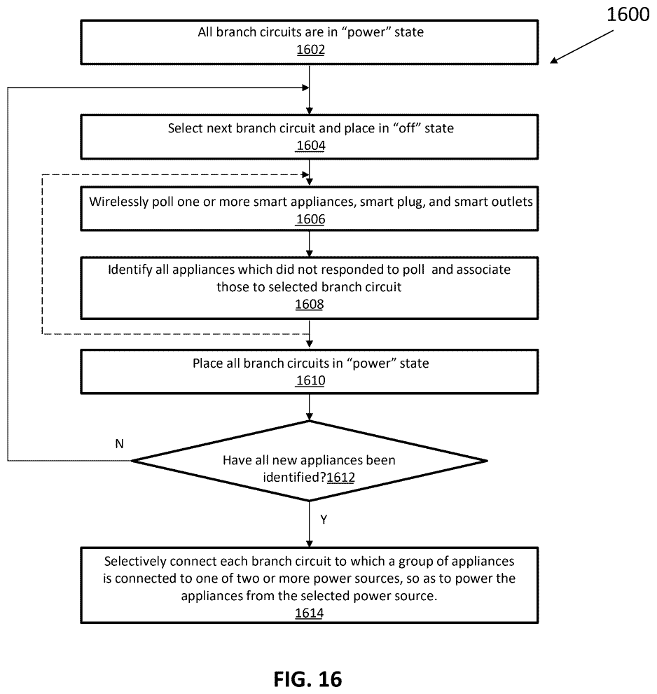

FIG. 16 depicts a method 1600, performed by CHC 510 (whether embedded in the SLC 402 or operating independently), of dynamically identifying which appliances are connected to which branch circuit when one or more new appliances are added in the facility. Each branch circuit is placed in a “POWER” state, meaning it is connected to the grid power or an alternative power source (block 1602). Next, one branch circuit is placed in an “OFF” state, where no power is provided to this branch circuit (block 1604). While one branch circuit is in “OFF” state, a wireless polling scheme is used to poll one or more smart appliances, smart plugs, and smart outlets (block 1606). All smart appliances, smart plugs, and smart outlets that have not responded to the wireless poll are associated with the selected branch circuit that has been placed in the “OFF” state (block 1608). As shown in FIG. 16, blocks 1606 and 1608 may be repeated when the duration of the “OFF” state of the selected branch circuit is short; this is indicated in FIG. 16 by a dashed arrow returning control to block 1606. All branch circuits are placed in “POWER” state again (block 1610). The procedure should be carried out until all new appliances have been identified (block 1612). If no new appliances have been identified on the selected branch circuit, the procedure is repeated (back to block 1604), selecting the next branch circuit. If all new appliances have been identified, the branch circuits are each “powered” with grid power or an alternative power source depending on the needs of the connected appliances (block 1614).

In all aspects, a microcontroller 1220, 1420 may comprise any sequential state machine operative to execute machine instructions stored as machine-readable computer programs stored in memory, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above. As used herein, the term “microcontroller” is synonymous with “processor,” “microprocessor,” and the like. As is well known in the art, microcontrollers include memory in the form of registers, and possibly on-board cache memory, and may also be operatively connected to external memory. In all aspects, such external memory 1225, 1425 may comprise any machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like. In some aspects, the software may be retrieved by the microcontroller 1220, 1420 from a carrier which may comprise an electronic signal, optical signal, or radio signal, in addition to, or in lieu of, a computer readable storage medium such as memory 1225, 1425.

For convenience of explanation and to convey the inventive concepts to those of skill in the art, aspects of the present disclosure have been described herein with reference to a residential installation - using terms such as “home automation;” using examples of smart appliances typically found in a home, such as a washing machine or refrigerator; and the like. However, those of skill in the art will readily recognize that the present disclosure is not limited to residential installations, and aspects described herein are readily and advantageously applied to various commercial and industrial facilities as well, such as office buildings, retail facilities, hospitals, campuses, factories, stadiums, and the like - indeed, any facility in which solar power may advantageously be utilized alongside utility grid power.

As used herein, the term “smart appliance” refers to a device, at least partially powered by electricity and plugged into an electrical outlet or hard-wired into a branch circuit in a facility, that includes a wireless transceiver. Smart appliances may be controlled by a smartphone app or otherwise join the IoT. Note that smart appliances are not limited to home-based machines for performing labor, but may include industrial equipment, computers, tools, lighting, HVAC, signs, and the like.

Aspects of the present disclosure present numerous advantages over the prior art. Although wireless architectures have been proposed for home automation and Internet-of-Things networks for the home or other facilities, none of them contemplate the dynamic, selective, and individual delivery to appliances of power from different power sources. Aspects of the present disclosure utilize ubiquitous, low-cost, high-bandwidth, optionally secure wireless communications to efficiently provide for appliance identification and association with branch circuits. This facilitates dynamic control of solar (or other alternate) power vs. grid power at the granularity of a branch circuit, maximizing the utility of the alternate power generation, with minimal additional cost and re-design required of modern smart appliances, which already include wireless transceivers.

Generally, all terms used herein are to be interpreted according to their ordinary meaning in the relevant technical field, unless a different meaning is clearly given and/or is implied from the context in which it is used. All references to a/an/the element, apparatus, component, means, step, etc., are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the aspects disclosed herein may be applied to any other aspect, wherever appropriate. Likewise, any advantage of any of the aspects may apply to any other aspects, and vice versa. Other objectives, features and advantages of the enclosed aspects will be apparent from the description.

As used herein, the term “configured to” means set up, organized, adapted, or arranged to operate in a particular way; the term is synonymous with “designed to,” or with respect to processing circuitry, “programmed to.”

Some of the aspects contemplated herein are described more fully with reference to the accompanying drawings. Other aspects, however, are contained within the scope of the subject matter disclosed herein. The disclosed subject matter should not be construed as limited to only the aspects set forth herein; rather, these aspects are provided by way of example to convey the scope of the subject matter to those skilled in the art.

The present disclosure may, of course, be constructed and practiced in other ways than those specifically set forth herein without departing from essential characteristics of the disclosure. The present aspects are to be considered in all respects as illustrative and not restrictive, and all changes coming within the meaning and equivalency range of the appended embodiments are intended to be embraced therein.

What is claimed is:

1. A method, performed by a Smart Load Center (SLC) controller, of dynamically, selectively, and individually delivering power from one of two or more sources to an appliance in a facility via a plurality of branch circuits, comprising the steps of:
selectively connecting each branch circuit to one of the two or more power sources;
turning off one branch circuit of a multitude of branch circuits in the facility;
sending a poll message to all appliances;
receiving from each appliance not connected to the turned-off branch circuit a response message;
determining from the received responses which appliances have not responded and are therefore connected to the branch circuit turned off;
selectively connecting the branch circuit to one of the two or more power sources, so as to power the appliances from the selected power source; and
repeating the steps for each branch circuit until appliances connected to all branch circuits are identified.

2. The method of embodiment 1, further comprising performing load balancing by dynamically controlling one or more identified appliances to begin, delay, or cease tasks.

3. The method of claim 1 wherein the poll messages and responses are sent wirelessly.

4. The method of claim 3 wherein the wireless transceiver is in the power plug of the appliance.

5. The method of claim 3 wherein the wireless transceiver is in the outlet the appliance is plugged in to.

6. The method of claim 1 wherein each appliance is sequentially polled individually.

7. The method of claim 1 wherein a single poll message is broadcasted to all appliances and the responses are received using a contention-free access mechanism.

8. The method of claim 1 wherein the step of polling consists of two or more polling time periods distributed over time, wherein in each polling period only a limited number of selected appliances are polled.

9. The method of claim 1 in which all branch circuits are turned off, sequentially only a single branch circuit is activated by connecting it to one of the two or more power sources, polling all appliances, and deriving from the responses which appliances are connected to the active branch circuit.

10. The method of claim 3 wherein the wireless communication is based on WiFi.

11. The method of claim 3 wherein the wireless communication is based on Bluetooth.

12. A method, performed by a smart appliance connected to a first branch circuit in a facility, of facilitating the dynamic, selective, and individual delivery of power from one of two or more sources to the smart appliance, comprising:
receiving a poll message from a controller in a Smart Load Center (SLC) configured to dynamically, selectively, and individually deliver power from one of two or more sources to each of a plurality of branch circuits;
transmitting to the SLC controller a response message; and
receiving power over the first branch circuit from one of the two or more sources, the power source selected by the SLC controller in response to the smart appliance response message.

13. The method of claim 12, further comprising dynamically beginning, delaying, or ceasing tasks in response to a command from the SLC controller.

14. The method of claim 12 wherein the poll messages and responses are sent wirelessly.

15. The method of claim 14 wherein the wireless transceiver is in the power plug of the appliance.

16. The method of claim 14 wherein transmitting the smart appliance response message is using a contention-free access mechanism.

17. The method of claim 14 wherein the wireless communication is based on WiFi.

18. The method of claim 14 wherein the wireless communication is based on Bluetooth.

19. The method of claim 12 wherein the smart appliance has a back-up battery, and a response message is only sent when the smart appliance detects that it is not using the back-up battery.

20. A Smart Load Center (SLC), comprising:
a first input operative to receive electrical power from a first power source;
a second input operative to receive electrical power from a second power source;
a plurality of branch circuit outputs;
a plurality of switches, each operative to connect a branch circuit alternatively to the first or second power source, or a powerless OFF state; and
an SLC controller including a wireless transceiver and configured to
switch a selected branch circuit to the powerless OFF state;
wirelessly broadcast a poll message to all appliances;
wirelessly receive from each appliance not connected the powerless branch circuit a response message;
determine from the received response messages which appliance is connected to the powerless branch circuit; and
control a switch associated with the selected branch circuit to supply power from the first or the second power source to the appliance.

21. The SLC of claim 20, wherein the controller is further configured to perform load balancing by dynamically controlling the smart appliance to begin, delay, or cease tasks.

22. A method, performed by a controller of a Smart Load Center (SLC) configured to receive AC electrical power from two or more sources, and to dynamically, selectively, and individually deliver power from one of the two or more sources to a plurality of individual branch circuits, wherein the SLC controller is configured to individually place each branch circuit in an ON state, wherein it is connected to one of the two or more power sources, or an OFF state, wherein it is disconnected from all power sources, the method being one of mapping appliances to the branch circuit to which they are connected, and comprising the steps of:
placing all of the branch circuits in one of the ON and OFF states;
individually placing one selected branch circuit in the other of the ON and OFF states;
sending a poll message to all appliances;
receiving poll responses from all appliances connected to branch circuits that are in the ON state; and
determining, from the received responses and lack of responses, which appliances are connected to the one selected branch circuit in the opposite of the ON and OFF states from the other branch circuits; and
repeating the method steps for each branch circuit until the all appliances connected to branch circuits are identified.

23. The method of claim 22, wherein the plurality of branch circuits comprises all branch circuits driven by the SLC.

24. The method of claim 22, wherein placing all of the branch circuits in one of the ON and OFF states comprises placing the branch circuits in the ON state.

25. The method of claim 22, wherein placing all of the branch circuits in one of the ON and OFF states comprises placing the branch circuits in the OFF state.
